(19) United States
(12) Patent Application Publication
(10) Pub. No.: US 2013/0328932 A1
(43) Pub. Date: Dec. 12, 2013

(54) ADD SOCIAL COMMENT KEEPING PHOTO CONTEXT

(71) Applicant: Samsung Electronics Co., Ltd, Suwon (KR)

(72) Inventors: Byoungju Kim, Walnut Creek, CA (US); Prashant Desai, San Francisco, CA (US); Jesse Alvarez, Oakland, CA (US)

(21) Appl. No.: 13/906,257

(22) Filed: May 30, 2013

Related U.S. Application Data
(60) Provisional application No. 61/657,594, filed on Jun. 8, 2012.
(60) Provisional application No. 61/780,711, filed on Mar. 13, 2013.

(51) Int. Cl. H04L 29/06; G06F 3/00; H04L 29/08; G09G 5/40

(52) U.S. Cl. CPC H04L 65/403; G09G 5/40; G06F 3/005; H04L 29/08549
USPC 345/636; 348/207.1; 709/216; 715/753; 709/204

(57) ABSTRACT

A method of sharing image comments comprises displaying an image on a display of an electronic device, adding a comment associated with the image, selecting one or more destinations for sharing the image and the associated comment, and sharing the image and the associated comment with the one or more selected destinations.

### CROSS-REFERENCE TO RELATED APPLICATIONS

This application claims the priority benefit of U.S. Provisional Patent Application Ser. No. 61/657,594, filed Jun. 8, 2012, and U.S. Provisional Patent Application Ser. No. 61/780,711, filed Mar. 13, 2013, incorporated herein by reference in its entirety.

### TECHNICAL FIELD

One or more embodiments relate generally to collaborative media editing and, in particular, to sharing media edit history and borrowing media edits on an electronic device.

### BACKGROUND

With the proliferation of electronic devices such as mobile electronic devices, users use the electronic devices for photo taking and photo editing. When a photo is taken or downloaded onto an electronic device, modification or editing of the photo is local to the electronic device.

### SUMMARY

One or more embodiments relate generally to using an electronic device for editing image content maintained in a network. One embodiment of the present invention provides sharing and using photo comments through a cloud environment.

In one embodiment, a method of sharing image comments comprises displaying an image on a display of an electronic device, adding a comment associated with the image, selecting one or more destinations for sharing the image and the associated comment, and sharing the image and the associated comment with the one or more selected destinations.

Another embodiment comprises an electronic device. The electronic device comprising a camera, a display and a mobile image gallery module. The mobile image gallery module provides for sharing comments associated with an image; wherein a comment associated with the image is shared within a network.

One embodiment comprises a computer program product for sharing image comments. The computer program product comprising a tangible storage medium readable by a computer system and storing instructions for execution by the computer system for performing a method. The method comprising displaying an image on a display of an electronic device. A comment associated with the image is added. One or more destinations are selected for sharing the image and the associated comment. The image and the associated comment are shared with the one or more selected destinations.

One embodiment comprises a graphical user interface (GUI) displayed on a display of an electronic device. The GUI comprising one or more comments related to an image displayed on the electronic device, a selectable comment portion for adding a new comment related to the image, and one or more selectable social platform icons each representing a different social platform. The new comment is associated with one or more social platforms for adding the new comment to the one or more selected social platforms.

One embodiment comprises a system including a server that provides a service for storing and communicating image content and associated comments. In one embodiment, an electronic device including a mobile image gallery module provides for sharing comments associated with an image. In one embodiment, a comment associated with the image is shared with one or more destinations using the server.

One embodiment comprises a server including a memory for storing image content and associated comments. In one embodiment, a service uses a processor for communicating comments associated with content for sharing across a plurality of social networks. In one embodiment, the comments are associated with content via electronic devices.

These and other aspects and advantages of the present invention will become apparent from the following detailed description, which, when taken in conjunction with the drawings, illustrate by way of example the principles of the one or more embodiments.

### BRIEF DESCRIPTION OF THE DRAWINGS

For a fuller understanding of the nature and advantages of the one or more embodiments, as well as a preferred mode of use, reference should be made to the following detailed description read in conjunction with the accompanying drawings, in which:

FIGS. 1A-1B show block diagrams of architecture on a system for sharing photo edits, according to an embodiment.

FIGS. 2A-2E show an example usage and visual transitions of social sharing of photo comments, according to an embodiment.

FIG. 3 shows a flowchart of a process for sharing photo comments, according to an embodiment.

FIG. 4 is a high-level block diagram showing an information processing system comprising a computing system implementing an embodiment.

FIG. 5 shows a computing environment for implementing an embodiment.

FIG. 6 shows a computing environment for implementing an embodiment.

FIG. 7 shows a computing environment for sharing comments and media, according to an embodiment.

FIG. 8 shows a block diagram of an architecture for a local endpoint host, according to an example embodiment.

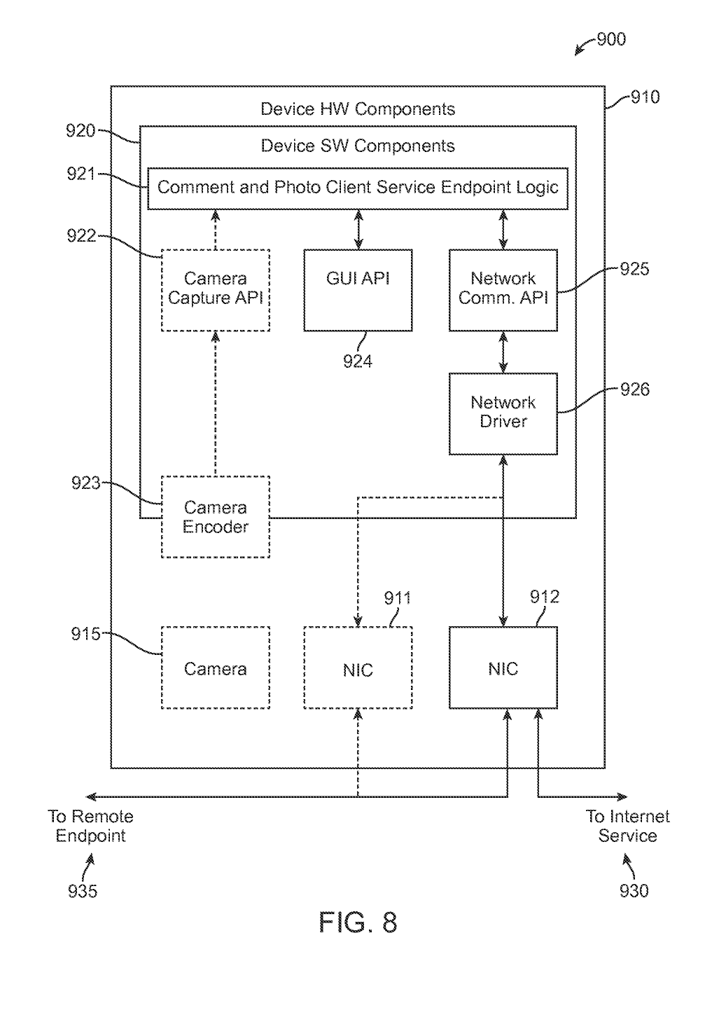

### DETAILED DESCRIPTION

The following description is made for the purpose of illustrating the general principles of the one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to using an electronic device for editing image content maintained in a network. One embodiment provides sharing and using photo comments through a cloud environment.

In one embodiment, the electronic device comprises a mobile electronic device capable of data communication over a communication link such as a wireless communication link. Examples of such mobile device include a mobile phone device, a mobile tablet device, smart mobile devices, wearable devices, etc.

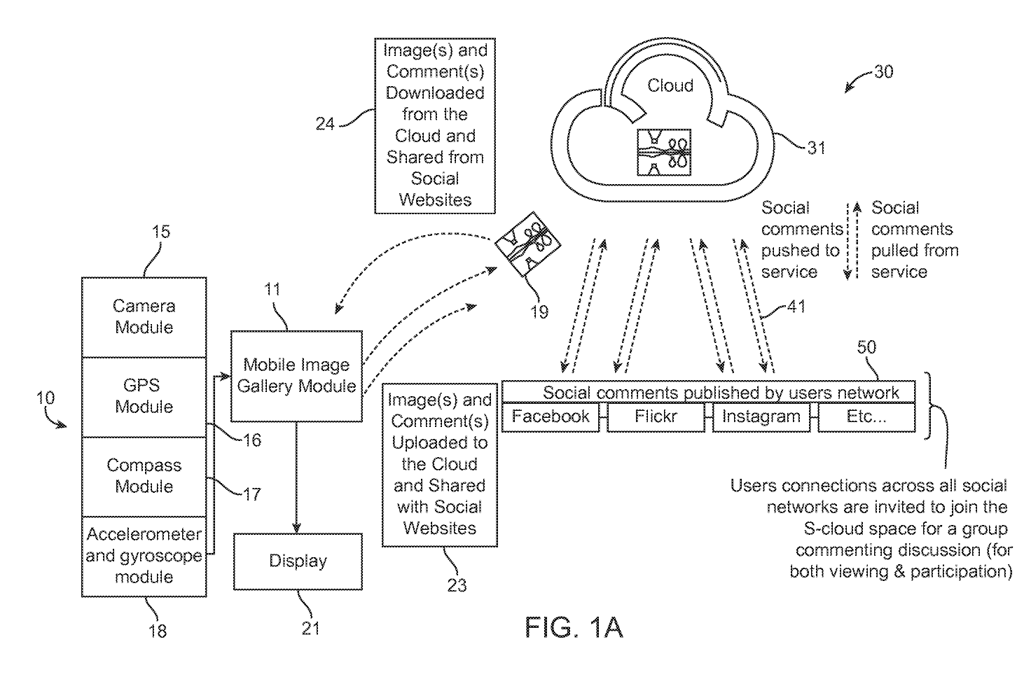

FIG. 1A shows a functional block diagram of an embodiment of a photo comment sharing system 10 for using an electronic device (such as mobile device 20 as shown in FIG. 1B) for sharing photo comments, according to an embodiment.

The system 10 comprises a mobile image gallery module 11 including an image selection module 12 (FIG. 1B), a comment editing module 13 (FIG. 1B), an access module 14 (FIG. 1B) and a social website selection module 25 (FIG. 1B). The mobile image gallery module 11 utilizes mobile device hardware functionality including one or more of: camera module 15, global positioning satellite (GPS) receiver module 16, compass module 17, and accelerometer and gyroscope module 18.

The camera module 15 is used to capture images of objects, such as people, surroundings, places, etc. The GPS module 16 is used to identify a current location of the mobile device 20 (i.e., user). The compass module 17 is used to identify direction of the mobile device. The accelerometer and gyroscope module 18 is used to identify tilt of the mobile device.

The system 10 provides photo comment editing, sharing of: photos, photo comments, and display of photo comments and photos on the display 21 of mobile device 20. The system 10 provides a simple, fluid, and responsive user experience.

The sharing of photos and photo comments comprises integrating information including camera data, editing data, social platform data, and optionally, location data, sensor data (i.e., magnetic field, accelerometer, rotation vector), etc. For example, Google Android mobile operating system application programming interface (API) components providing such information can be employed.

In one embodiment, a user aims a camera of a mobile device (e.g., smartphone, tablet, smart device) including the mobile image gallery module 11, towards a target object, for example, an object, scene or person at a physical location, such as a city center the user is visiting, and takes a photo. The photo from the camera application (e.g., camera module 15) is processed by the mobile device 20 and displayed on a display 21 of the mobile device 20.

In one embodiment, one or more photo images 19 and images and comments 23 are uploaded (i.e., pushed) from the mobile image gallery module 11 of mobile device 20 to a network 30 (e.g., using transceiver 22) including a cloud environment 31, or photo images 19 and images and comments 24 may be downloaded (i.e., pulled) from the network 30 (e.g., using a transceiver 22 as shown in FIG. 1B) to the mobile image gallery module 11 of mobile device 20.

In one embodiment, social comments 50 are published by users to the cloud environment 31 via a service 41 (e.g., pushed/pulled, wirelessly or wired, etc.). In one implementation, the user connections across all social networks are invited to join the cloud environment 31 to both view and participate in a group commenting discussion. From the cloud environment 31, images and comments are downloaded/pulled from the cloud environment 31 and shared from social websites 24, and images and comments are uploaded/pushed to the cloud environment 31 and shared with social websites 23.

In one example, a photo image 19 that is maintained in the cloud environment 31 of the network 30 or maintained by social networking services that hosts image collections and enables commenting on the images may be accessed by users in the mobile device 20. In one implementation, a photo image that has a comment from one or more users of one or more social platforms (e.g., Instagram®, Facebook®, Flickr®, Google+®, etc.) may be selected for display. In one embodiment, the selected photo image appears in the display with a social view icon, which informs the user that the photo includes comments from one or more social platforms. In one example, multiple comments may be displayed along with a thumbnail of the connection (i.e., social network space user/member) and icon of the associated social platform. A user may then add a comment to the selected photo image and select one or more desired social platform destinations to which the image would be pushed/uploaded and upon which the image may be commented. The image with the new comment is then shared and may be accessed from the social platforms or from the cloud environment 31.

In one embodiment, once activated, the mobile image gallery module 11 enables the user to add a comment to a photo image (e.g., using a touch screen 26 in FIG. 1B) they selected on the display 21. In one embodiment, using the mobile image gallery module 11, the comment added to the photo image is stored locally to a memory of the mobile device 20 and tracked in the order made. In one example, time/date stamps and location information may be provided in metadata for a comment.

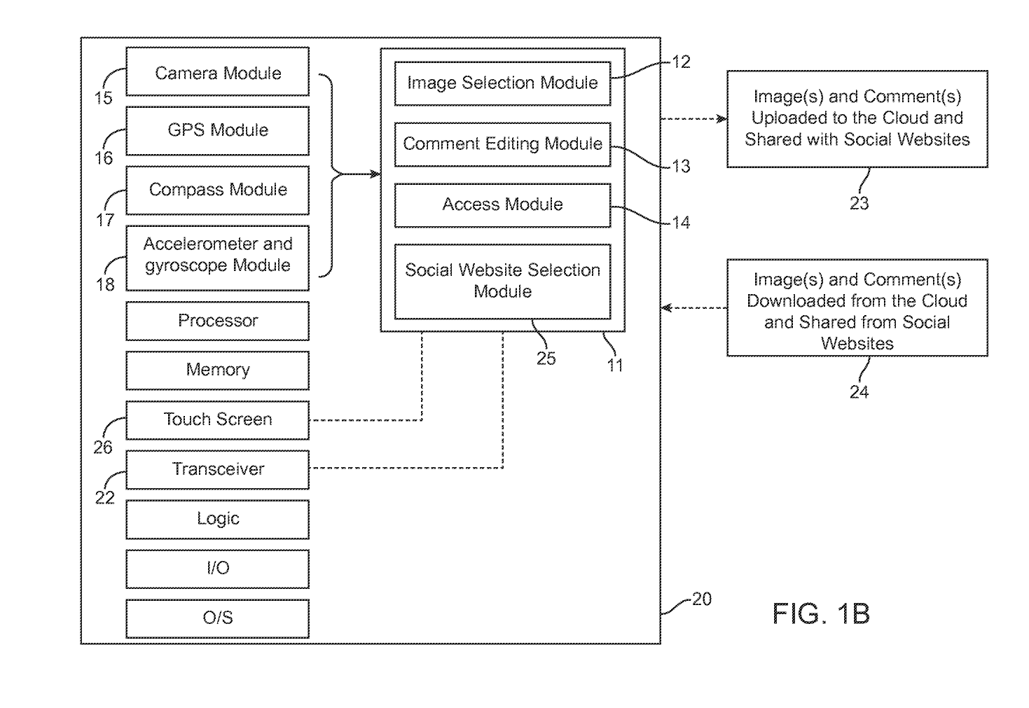

FIGS. 2A-2E show an example usage and visual transitions for adding a comment to a photo and social sharing of the photo comment for a photo image 210 that is selected using the image selection module 12. FIG. 2A shows photo image 210 on a display format 200 including a social view icon 220 that indicates that the photo image 210 is associated with one or more comments from one or more social network platforms. In one embodiment, tapping of the social view icon 220 by a user initiates the transition for viewing comments associated with the photo image 210 by the image gallery module 11.

FIG. 2B shows the transition after the social view icon 220 has been tapped using the touch screen 26. In one embodiment, the photo image 210 is transitioned to a thumbnail image 230. FIG. 2C shows the transition display where associated comments 270 are displayed on the display format 200. In one implementation, each associated comment 270 shown includes a thumbnail of the connection 275 (e.g., user photo, user icon, user avatar, etc.) and a representative icon 280 of the associated social platform to which the comment 270 was posted. The display format 200 includes the thumbnail 240 of the photo image 210 that is resized (i.e., reduced in size) on the display 200, comment editing field 250, send button 260, and social platform selections 245. In one embodiment, the social platform selections 245 include one or more icons representing different social platforms that a user may select for posting the photo with an added comment.

FIG. 2D shows the selection by tapping on the comment editing field 250 via the touch screen 26 to transition to display format 200 enabling comment editing mode. FIG. 2E shows the transition with the comment editing enabled. In one implementation, the keyboard 290 is shown on the display format 200 that enables a user to edit a comment for the photo image 210. Once the comment has been entered into the comment edit field 250 and the user has selected the desired social platform selections 245, the send button 260 may be tapped so that the photo image 210 with the added comment from the comment edit field 250 may be pushed to the selected social network platforms via the transceiver 22.

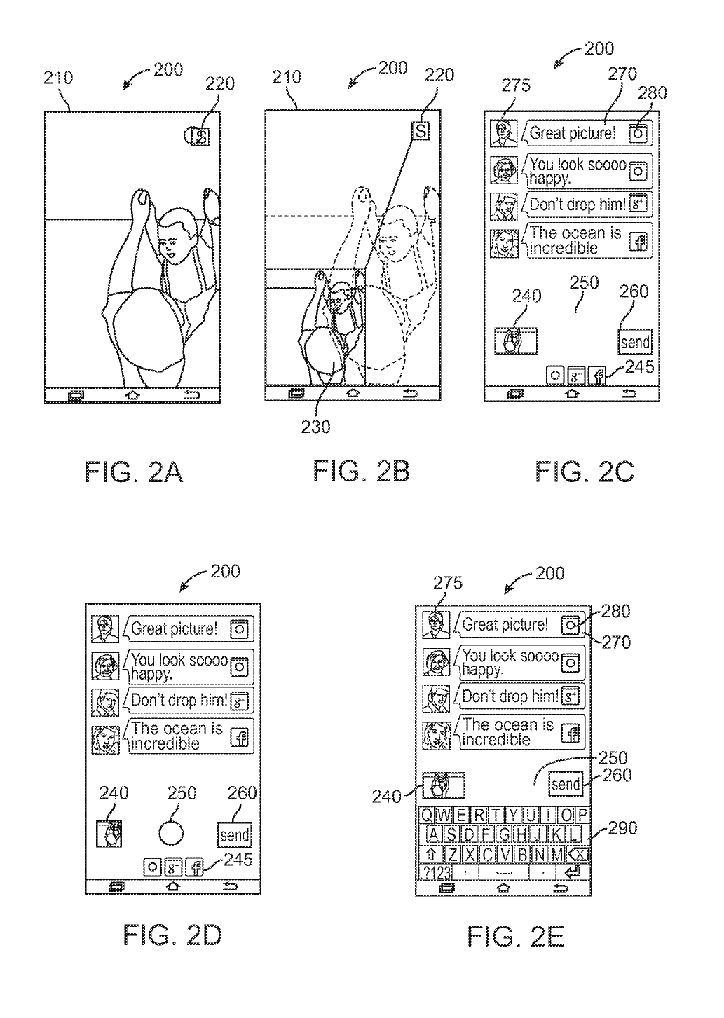

FIG. 3 shows a flowchart of an image comment adding and sharing process 300, according to an embodiment. Process block 310 comprises displaying an image on a display of an electronic device. Process block 320 comprises adding a comment associated with an image. Process block 330 comprises, selecting one or more destinations (e.g., social platforms) for sharing the image and associated comment. Process block 340 comprises sharing the image and the associated comment with the one or more selected destinations.

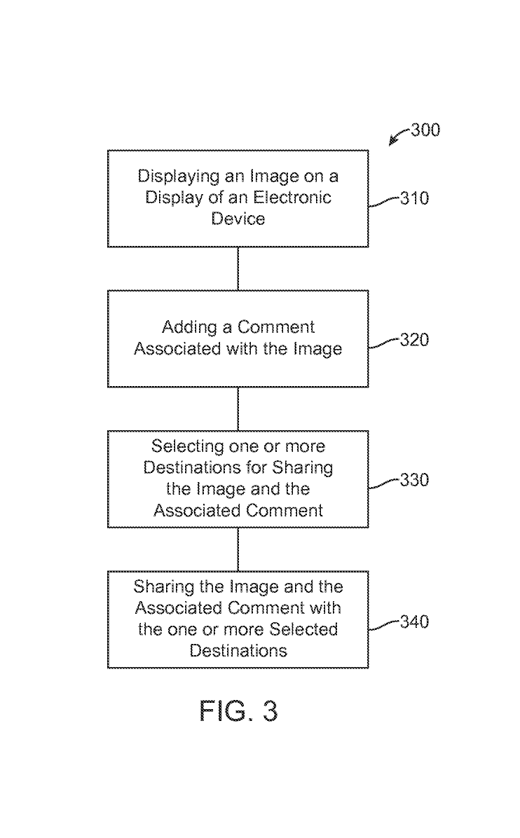

FIG. 4 is a high-level block diagram showing an information processing system comprising a computing system 500 implementing an embodiment. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as WiFi, Cellular), a network interface (such as an Ethernet card), a communications port, or a PCMCIA slot and card). The communication interface 517 allows software and data to be transferred between the computer system and external devices. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

In one example embodiment, in a mobile wireless device such as a mobile phone, the system 500 further includes an image capture device such as a camera 15. The system 500 may further include application modules as MMS module 521, SMS module 522, email module 523, social network interface (SNI) module 524, audio/video (AV) player 525, web browser 526, image capture module 527, etc.

The system 500 further includes a mobile image gallery module 11 as described herein, according to an embodiment. In one implementation of said mobile image gallery module 11 along an operating system 529 may be implemented as executable code residing in a memory of the system 500. In another embodiment, such modules are in firmware, etc.

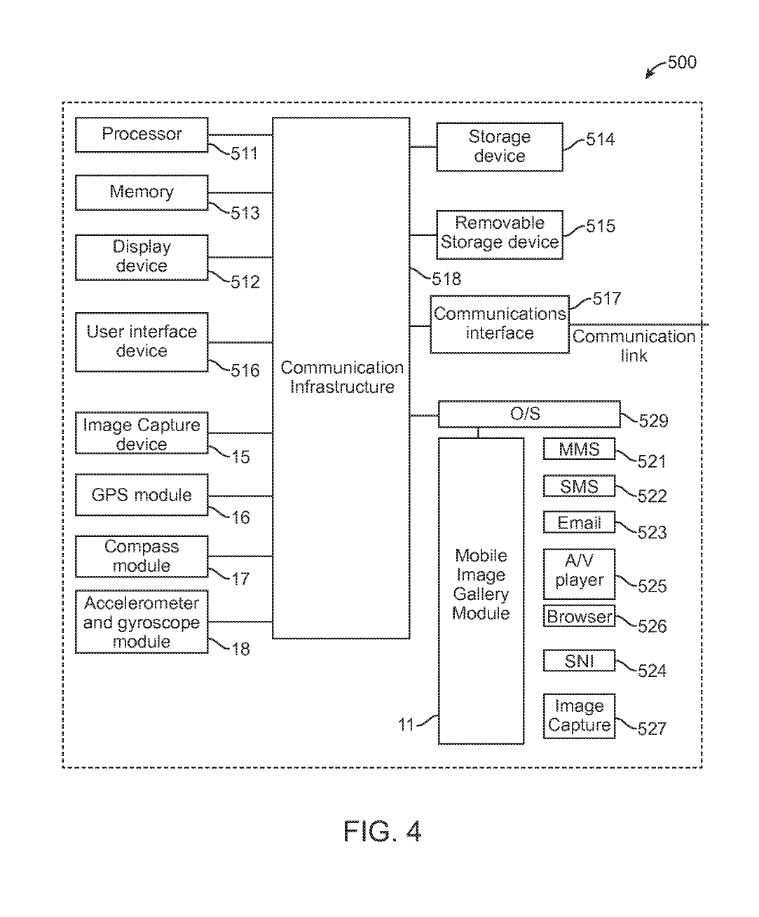

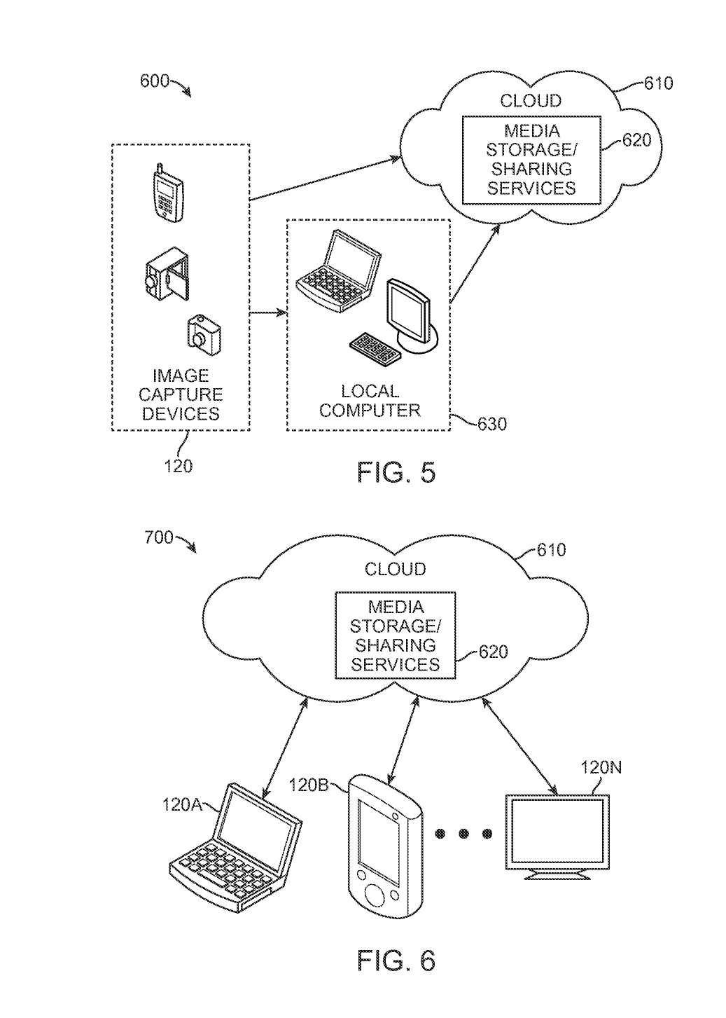

FIGS. 5 and 6 illustrate examples of networking environments 600 and 700 for cloud computing in which media and comment sharing embodiments described herein may utilize. In one embodiment, in the environment 600, the cloud 610 provides services 620 (such as media and comment sharing, social networking services, among other examples) for user computing devices, such as electronic device 120. In one embodiment, services may be provided in the cloud 610 through cloud computing service providers, or through other providers of online services. In one example embodiment, the cloud-based services 620 may include media processing and sharing services that uses any of the techniques disclosed, a media storage service, a social networking site, or other services via which media (e.g., from user sources) are stored and distributed to connected devices.

In one embodiment, various electronic devices 120 include image or video capture devices to capture one or more images or video, create or share comments, etc. In one embodiment, the electronic devices 120 may upload the comments for one or more digital images to the service 620 on the cloud 610 either directly (e.g., using a data transmission service of a telecommunications network) or by first transferring the comments and/or one or more images to a local computer 630, such as a personal computer, mobile device, wearable device, or other network computing device.

In one embodiment, as shown in environment 700 in FIG. 6, cloud 610 may also be used to provide services that include comment and media sharing embodiments to connected electronic devices 120A-120N that have a variety of screen display sizes. In one embodiment, electronic device 120A represents a device with a mid-size display screen, such as what may be available on a personal computer, a laptop, or other like network-connected device. In one embodiment, electronic device 120B represents a device with a display screen configured to be highly portable (e.g., a small size screen). In one example embodiment, electronic device 120B may be a smartphone, PDA, tablet computer, portable entertainment system, media player, wearable device, or the like. In one embodiment, electronic device 120N represents a connected device with a large viewing screen. In one example embodiment, electronic device 120N may be a television screen (e.g., a smart television) or another device that provides image output to a television or an image projector (e.g., a set-top box or gaming console), or other devices with like image display output. In one embodiment, the electronic devices 120A-120N may further include image capturing hardware. In one example embodiment, the electronic device 120B may be a mobile device with one or more image sensors, and the electronic device 120N may be a television coupled to an entertainment console having an accessory that includes one or more image sensors.

In one or more embodiments, in the cloud-computing network environments 600 and 700, any of the embodiments may be implemented at least in part by cloud 610. In one embodiment example, comment and media sharing techniques are implemented in software on the local computer 630, one of the electronic devices 120, and/or electronic devices 120A-N. In another example embodiment, the content or media sharing techniques are implemented in the cloud and applied to comments and media as they are uploaded to and stored in the cloud. In this scenario, the comment and media sharing embodiments may be performed using media stored in the cloud as well.

In one or more embodiments, comments for media are shared across one or more social platforms from a single electronic device 120. Typically, the shared media is only available to a user if the friend or family member shares it with the user by manually sending the media (e.g., via a multimedia messaging service (“MMS”)) or granting permission to access from a social network platform. Once the media is created and viewed, people typically enjoy sharing them with their friends and family, and sometimes the entire world. Viewers of the media will often want to add a comment or their own thoughts and feelings about the media using paradigms like comments, “likes,” and tags of people. Traditionally, this type of supplemental social data is made via separate social media platforms or applications (e.g., apps). Using embodiments of the disclosed technology, comment data may be created on an electronic device 120 and uploaded for sharing to one or more social platforms without having to use separate applications for each selected social platform.

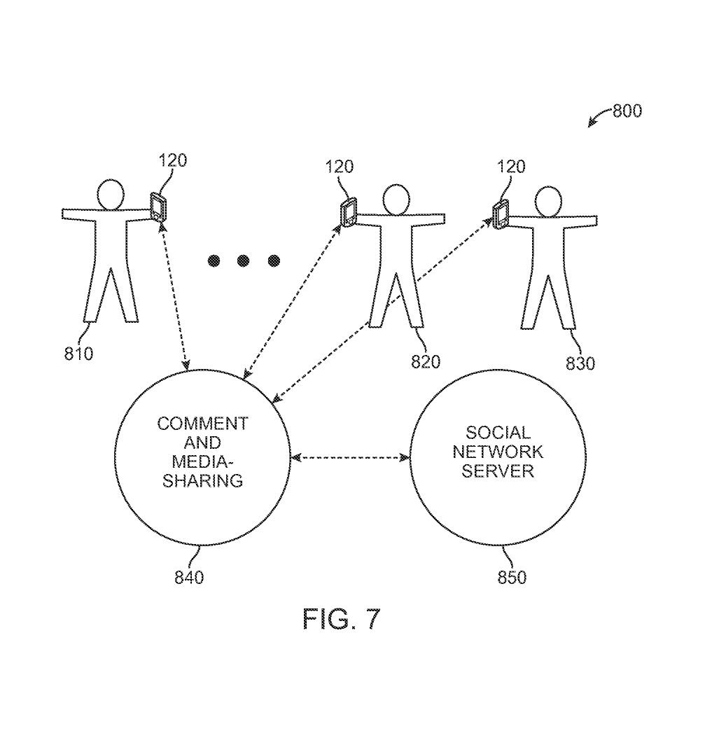

FIG. 7 is a block diagram 800 illustrating example users of a comment and media sharing system according to an embodiment. In one embodiment, users 810, 820, 830 are shown, each having a respective electronic device 120 that is capable of capturing digital media (e.g., images, video, audio, or other such media) and creating comments (e.g., text, graphics, etc.). In one embodiment, the electronic devices 120 are configured to communicate with a comment and media sharing controller 840, which is may be a remotely-located server, but may also be a controller implemented locally by one of the electronic devices 120. In one embodiment where the comment and media sharing controller 840 is a remotely-located server, the server may be accessed using the wireless modem, communication network associated with the electronic device 120, etc. In one embodiment, the comment and media sharing controller 840 is configured for two-way communication with the electronic devices 120. In one embodiment, the comment and media sharing controller 820 is configured to communicate with and access data from one or more social network servers 850 (e.g., over a public network, such as the Internet).

In one embodiment, the social network servers 850 may be servers operated by any of a wide variety of social network providers (e.g., Facebook®, Instagram®, Flickr®, and the like) and generally comprise servers that store information about users that are connected to one another by one or more interdependencies (e.g., friends, business relationship, family, and the like). Although some of the user information stored by a social network server is private, some portion of user information is typically public information (e.g., a basic profile of the user that includes a user's name, picture, and general information). Additionally, in some instances, a user's private information may be accessed by using the user's login and password information. The information available from a user's social network account may be expansive and may include one or more lists of friends, current location information (e.g., whether the user has “checked in” to a particular locale), additional images of the user or the user's friends. Further, the available information may include additional information (e.g., metatags in user photos indicating the identity of people in the photo or geographical data. Depending on the privacy setting established by the user, at least some of this information may be available publicly. In one embodiment, a user that desires to allow access to his or her social network account for purposes of aiding the comment or media sharing controller 840 may provide login and password information through an appropriate settings screen. In one embodiment, this information may then be stored by the comment and media sharing controller 840. In one embodiment, a user's private or public social network information may be searched and accessed by communicating with the social network server 850, using an application programming interface (“API”) provided by the social network operator.

In one embodiment, the comment and media sharing controller 840 performs operations associated with a comment and media sharing application or method. In one example embodiment, the comment and media sharing controller 840 may receive media from a plurality of users (or just from the local user), determine relationships between two or more of the users (e.g., according to user-selected criteria), and transmit comments and/or media to one or more users based on the determined relationships.

In one embodiment, the comment and media sharing controller 840 need not be implemented by a remote server, as any one or more of the operations performed by the comment and media sharing controller 840 may be performed locally by any of the electronic devices 120, or in another distributed computing environment (e.g., a cloud computing environment). In one embodiment, the sharing of comments and/or media may be performed locally at the electronic device 120.

FIG. 9 shows an architecture for a local endpoint host 900, according to an embodiment. In one embodiment, the local endpoint host 900 comprises a hardware (HW) portion 810 and a software (SW) portion 920. In one embodiment, the HW portion 910 comprises the camera 815, network interface (NIC) 911 (optional) and NIC 912 and a portion of the camera encoder 923 (optional). In one embodiment, the SW portion 920 comprises comment and photo client service endpoint logic 921, camera capture API 922 (optional), a graphical user interface (GUI) API 924, network communication API 925, and network driver 926. In one embodiment, the content flow (e.g., text, graphics, photo, video and/or audio content, and/or reference content (e.g., a link)) flows to the remote endpoint in the direction of the flow 935, and communication of external links, graphic, photo, text, video and/or audio sources, etc. flow to a network service (e.g., Internet service) in the direction of flow 930.

One or more embodiments, use features of WebRTC for acquiring and communicating streaming data. In one embodiment, the use of WebRTC implements one or more of the following APIs: MediaStream (e.g., to get access to data streams, such as from the user's camera and microphone), RTCPeerConnection (e.g., audio or video calling, with facilities for encryption and bandwidth management), RTCDataChannel (e.g., for peer-to-peer communication of generic data), etc.

In one embodiment, the MediaStream API represents synchronized streams of media. For example, a stream taken from camera and microphone input may have synchronized video and audio tracks. One or more embodiments may implement an RTCPeerConnection API to communicate streaming data between browsers (e.g., peers), but also use signaling (e.g., messaging protocol, such as SIP or XMPP, and any appropriate duplex (two-way) communication channel) to coordinate communication and to send control messages. In one embodiment, signaling is used to exchange three types of information: session control messages (e.g., to initialize or close communication and report errors), network configuration (e.g., a computer's IP address and port information), and media capabilities (e.g., what codecs and resolutions may be handled by the browser and the browser it wants to communicate with).

In one embodiment, the RTCPeerConnection API is the WebRTC component that handles stable and efficient communication of streaming data between peers. In one embodiment, an implementation establishes a channel for communication using an API, such as by the following processes: client A generates a unique ID, Client A requests a Channel token from the App Engine app, passing its ID, App Engine app requests a channel and a token for the client's ID from the Channel API, App sends the token to Client A, Client A opens a socket and listens on the channel set up on the server. In one embodiment, an implementation sends a message by the following processes: Client B makes a POST request to the App Engine app with an update, the App Engine app passes a request to the channel, the channel carries a message to Client A, and Client A's onmessage callback is called.

In one embodiment, WebRTC may be implemented for a one-to-one communication, or with multiple peers each communicating with each other directly, peer-to-peer, or via a centralized server. In one embodiment, Gateway servers may enable a WebRTC app running on a browser to interact with electronic devices.

In one embodiment, the RTCDataChannel API is implemented to enable peer-to-peer exchange of arbitrary data, with low latency and high throughput. In one or more embodiments, WebRTC may be used for leveraging of RTCPeerConnection API session setup, multiple simultaneous channels, with prioritization, reliable and unreliable delivery semantics, built-in security (DTLS), and congestion control, and ability to use with or without audio or video.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said architecture can take the form of an entirely hardware embodiment, an entirely software embodiment or an embodiment containing both hardware and software elements.

Embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the one or more embodiments have been described with reference to certain versions thereof; however, other versions are possible. Therefore, the spirit and scope of the appended claims should not be limited to the description of the preferred versions contained herein.

What is claimed is:

1. A method of sharing image comments comprising:
displaying an image on a display of an electronic device;
adding a comment associated with the image;
selecting one or more destinations for sharing the image and the associated comment; and
sharing the image and the associated comment with the one or more selected destinations.

2. The method of claim 1, further comprising:
reducing the image to a thumbnail size image on the display; and
displaying one or more comments associated with the image on the display.

3. The method of claim 2, further comprising:
inviting one or more contacts to join together for a group commenting discussion associated with the image.

4. The method of claim 1, further comprising:
displaying a social view icon with the image on the display; and
selecting the social view icon for displaying one or more comments associated with the image, wherein the one or more comments are related to one or more social media websites.

5. The method of claim 4, wherein sharing the image and the associated comment comprises:
pushing the image and the associated comment to a network; and
transferring the image and the associated comment from the network to one or more social media platforms.

6. The method of claim 5, wherein transferring the image and the associated comment comprises one of pushing the image and the associated comment to the one or more social media platforms or pulling the image and the associated comment from the one or more social media platforms.

7. The method of claim 6, wherein the network is a cloud network.

8. The method of claim 1, wherein the electronic device comprises a mobile electronic device.

9. The method of claim 8, wherein the mobile electronic device comprises one of a mobile phone, a tablet device, and a mobile computing device.

10. The method of claim 2, wherein the one or more comments are each associated with a contact from a social media platform.

11. An electronic device, comprising:
a camera;
a display; and
a mobile image gallery module that provides for sharing comments associated with an image;
wherein a comment associated with the image is shared within a network.

12. The electronic device of claim 11, wherein the electronic device provides for downloading of image content and associated comments from the network, wherein uploaded image content and associated comments are shared across one or more social media platforms.

13. The electronic device of claim 12, wherein the mobile image gallery module provides for selecting an image for view on the display, adding a comment and associating the comment with the selected image, selecting one or more destinations for sharing the image and the added associated comment, and sharing the image and the added associated comment with the one or more selected destinations.

14. The electronic device of claim 13, wherein the mobile image gallery module reduces the selected image to a thumbnail size image on the display, and displays one or more comments associated with the image on the display.

15. The electronic device of claim 13, wherein the mobile image gallery module displays a social view icon with the image on the display, wherein the social view icon is selectable for displaying one or more comments associated with the image, and the one or more comments are related to one or more social media websites.

16. The electronic device of claim 13, wherein the network is a cloud network.

17. The electronic device of claim 11, wherein the electronic device comprises a mobile electronic device.

18. A computer program product for sharing image comments, the computer program product comprising:
a tangible storage medium readable by a computer system and storing instructions for execution by the computer system for performing a method comprising:
displaying an image on a display of an electronic device;
adding a comment associated with the image;
selecting one or more destinations for sharing the image and the associated comment; and
sharing the image and the associated comment with the one or more selected destinations.

19. The computer program product of claim 18, further comprising:
reducing the image to a thumbnail size image on the display; and
displaying one or more comments associated with the image on the display.

20. The computer program product of claim 19, further comprising:
inviting one or more contacts to join together for a group commenting discussion associated with the image;
displaying a social view icon with the image on the display; and
selecting the social view icon for displaying one or more comments associated with the image, wherein the one or more comments are related to one or more social media websites.

21. The computer program product of claim 20, wherein sharing the image and the associated comment comprises:
pushing the image and the associated comment to a network; and
transferring the image and the associated comment from the network to one or more social media platforms.

22. The computer program product of claim 21, wherein transferring the image and the associated comment comprises one of pushing the image and the associated comment to the one or more social media platforms or pulling the image and the associated comment from the one or more social media platforms.

23. The computer program product of claim 20, wherein the network is a cloud network, and the one or more comments are each associated with a contact from a social media platform.

24. The computer program product of claim 18, wherein the electronic device comprises a mobile electronic device.

25. A graphical user interface (GUI) displayed on a display of an electronic device, comprising:
one or more comments related to an image displayed on the electronic device;
a selectable comment portion for adding a new comment related to the image; and
one or more selectable social platform icons each representing a different social platform, wherein the new comment is associated with one or more social platforms for adding the new comment to the one or more selected social platforms.

26. The GUI of claim 25, wherein the image is reduced to a thumbnail upon displaying the one or more comments.

27. A system, comprising:
a server that provides a service for storing and communicating image content and associated comments; and
an electronic device including a mobile image gallery module that provides for sharing comments associated with an image;
wherein a comment associated with the image is shared with one or more destinations using the server.

28. The system of claim 27, wherein the mobile image gallery module provides for selecting an image for view on the electronic device, adding a comment and associating the comment with the selected image, selecting the one or more destinations for sharing the image and the added associated comment, and sharing the image and the added associated comment with the one or more selected destinations.

29. The system of claim 27, wherein the server is part of a cloud network, and the electronic device comprises a mobile electronic device.

30. A server, comprising:
a memory for storing image content and associated comments; and
a service that uses a processor for communicating comments associated with content for sharing across a plurality of social networks, wherein the comments are associated with content via electronic devices.

31. The server of claim 30, wherein the server communicates the comments associated with content based on destination selections received from the electronic devices.

32. The server of claim 31, wherein the content comprises photos with associated comments.

33. The server of claim 32, wherein the server is part of a cloud network, and the electronic devices comprises mobile electronic devices.
